(19) United States
(12) Patent Application Publication
(10) Pub. No.: US 2021/0056292 A1
(43) Pub. Date: Feb. 25, 2021

(54) IMAGE LOCATION IDENTIFICATION

(71) Applicants: Hewlett-Packard Development Company, L.P., Spring, TX (US); Purdue Research Foundation, West Lafayette, IN (US)

(72) Inventors: Ruiyi Mao, Palo Alto, CA (US); Qian Lin, Palo Alto, CA (US); Jan Allebach, Boise, ID (US)

(73) Assignees: Hewlett-Packard Development Company, L.P., Spring, TX (US); Purdue Research Foundation, West Lafayette, IN (US)

(21) Appl. No.: 17/043,067

(22) PCT Filed: May 17, 2018
(86) PCT No.: PCT/US2018/033184

§ 371 Date: Sep. 29, 2020

(51) Int. Cl. G06K 9/00; G06T 7/11; G06N 3/04

(52) U.S. Cl. CPC G06K 9/00281; G06T 7/11; G06T 2207/30201; G06N 3/0454; G06T 2207/20084; G06K 9/00288

(57) ABSTRACT

An example system includes a global location engine to identify a first plurality of locations of interest in an image. The global location engine is to identify the first plurality of locations based on a first neural network. The system also includes a segmentation engine to generate a regional image based on the image. The system includes a local location engine to identify a second plurality of locations of interest based on the regional image and at least a portion of the first plurality of locations of interest. The local location engine is to identify the second plurality of locations of interest based on a second neural network.

### BACKGROUND

A computing device may capture images. For example, the computing device may be communicatively coupled to a camera separate from the computing device, or the camera may be integrated into the computing device. Once captured, the images may be stored digitally in the computing device. For example, an image may be represented by a plurality of pixel values, such as grayscale values for red, green, and blue components at that pixel. The image may include a two-dimensional array of pixels. The locations of the pixels may be represented as horizontal or vertical offsets from a particular corner of the image. The horizontal or vertical offset may be expressed as a number of pixels.

### BRIEF DESCRIPTION OF THE DRAWINGS

FIG. 1 is a block diagram of an example system to identify locations of interest in an image.

FIG. 2 is a block diagram of another example system to identify locations of interest in an image.

FIG. 3 is a flow diagram of an example method to determine facial landmarks in an image.

FIG. 4 is a flow diagram of another example method to determine facial landmarks in an image.

FIG. 5 is a block diagram of an example computer-readable medium including instructions that cause a processor to determine facial landmarks in an image.

FIG. 6 is a block diagram of another example computer-readable medium including instructions that cause a processor to determine facial landmarks in an image.

### DETAILED DESCRIPTION

The camera may capture an image of a face. For example, a user may capture an image of the user's own face, a security camera may capture an image of a face, or the like. The computing device may perform any of various operations based on the image of the face. For example, the computing device may track the location of the face. The computing device may indicate the location of the face in the image. The computing device may zoom in digitally or optically on the face. The computing device may track the face by modifying a camera orientation or by modifying which portion of the image is zoomed. The computing device may perform facial recognition. The computing device may authenticate the user based on the facial recognition, may label an image based on the identification of the face with the facial recognition, or the like. The computing device may determine an emotion of the face. The computing device may modify an expression on a face of an animated character to match an expression of the face in the image. In an example, the computing device may modify the face in the image. The computing device may modify the image to add digital makeup to the face, to add facial decorations to the face, to distort features of the face, or the like. Users may enjoy modifying their faces with digital makeup, decorations, or distortion.

The various operations may depend on identifying the locations of facial landmarks. As used herein, the terms “determining a facial landmark” or “identifying a facial landmark” refer to determining or identifying a location of that facial landmark. The facial landmarks may correspond to body parts of the face, such as eye brows, eyes, nose, mouth, facial contour, or the like. There may be multiple facial landmarks for each body part. For example, a plurality of landmarks may circumscribe each body part. The computing device may identify the plurality of landmarks and use the plurality of landmarks as an input to a face tracking operation, a facial recognition operation, an emotion recognition operation, a facial modification operation, or the like. In an example, the computing device may use a neural network, such as a convolutional neural network, to identify the locations of the facial landmarks. The accuracy of the computing device in identifying the locations of the facial landmarks may affect how well the operations relying on the landmarks perform.

In an example, the neural network may include numerous layers to improve the accuracy of the identification of facial landmark locations. However, such a neural network may be unable to identify the locations of the facial landmarks in real time. For example, a mobile device with limited processing capabilities may be unable to use such a neural network to identify the locations of the facial landmarks in image frames of a video in real-time with the capturing of those image frames (e.g., in a time less than or equal to the period between the capturing of the image frames). Accordingly, such a neural network may be unsuited for use with operations that provide a real-time user experience.

Using multiple smaller neural networks to identify the locations of the facial landmarks may provide real-time performance while maintaining an acceptable level of accuracy. For example, a first neural network may determine the locations of facial landmarks based on an image of the entire face, and a plurality of second neural networks may determine the locations of facial landmarks for particular facial body parts based on cropped images of those body parts. The plurality of second neural networks may improve the accuracy of the locations identified over the locations identified by the first neural network. However, for some images, the second neural networks may not perform as well as the first neural network at identifying the locations of the facial landmarks. For example, when a body part is occluded, the second neural networks may be less accurate at identifying the locations of the facial landmarks for that body part than the first neural network. Accordingly, the identification of the locations of facial landmarks would provide more accurate results if the second neural networks performed at least as well the first neural network even when occlusions or the like impeded the performance of the second neural networks.

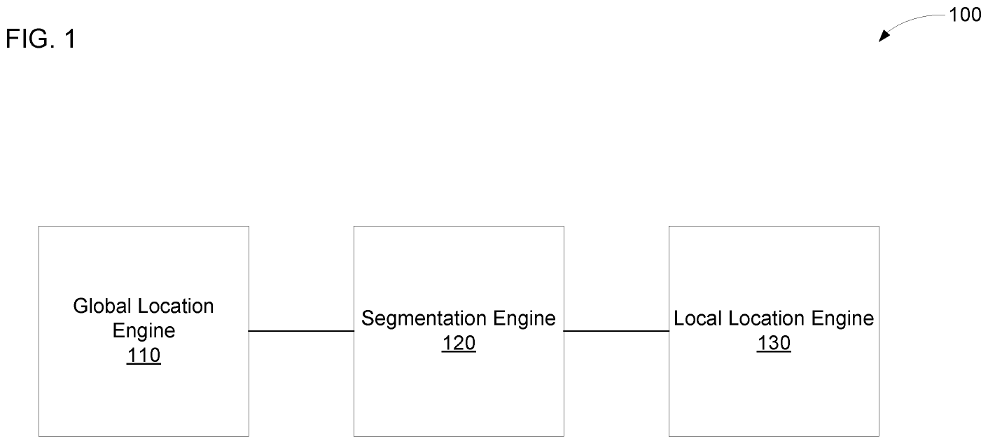

FIG. 1 is a block diagram of an example system 100 to identify locations of interest in an image. The system 100 may include a global location engine 110. As used herein, the term “engine” refers to hardware (e.g., a processor, such as an integrated circuit or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or executed or interpreted by a processor), or hardware and software hosted at hardware.

The global location engine 110 may identify a first plurality of locations of interest in an image. The first plurality of locations of interest may be facial landmarks, image features, or the like. The global location engine 110 may identify the first plurality of locations based on a first neural network. For example, the global location engine 110 may use the image as an input to the first neural network, and the global location engine 110 may generate the first plurality of locations as outputs from the first neural network.

The system 100 may include a segmentation engine 120. The segmentation engine 120 may generate a regional image based on the image. For example, the segmentation engine 120 may crop the image to generate the regional image. The segmentation engine 120 may identify where to crop the image based on the first plurality of locations, or the segmentation engine 120 may independently analyze the image to determine where to crop.

The system 100 may include a local location engine 130. The local location engine 130 may identify a second plurality of locations of interest. The local location engine 130 may identify the second plurality of locations of interest based on the regional image and at least a portion of the first plurality of locations of interest. As used herein, the term “at least a portion” refers to a portion smaller than a whole or the whole of the object being modified. The local location engine 130 may identify the second plurality of locations of interest based on a second neural network. For example, the local location engine 130 use the regional image and some or all of the first plurality of locations of interest as inputs to the second neural network. The local location engine 130 may generate the second plurality of locations of interest as outputs from the second neural network. Because the local location engine 130 uses at least a portion of the first plurality of locations of interest as an input, the local location engine 130 is less likely to generate a second plurality of locations of interest that is inconsistent with the first plurality of locations of interest. Accordingly, the local location engine 130 is less likely to perform more poorly than the global location engine 110 even when the regional image includes occluded content.

The second plurality of locations of interest may be the locations of interest provided to other engines for further processing. In some examples, the second plurality of locations of interest may be combined with at least a portion of the first plurality of locations of interest to create a final set of locations of interest. Although the illustrated example includes a single segmentation engine 120 and a single local location engine 130, other examples may include multiple segmentation engines 120 or a single segmentation engine 120 that generates multiple regional images or may include a plurality of local location engines 130 for various regions of the image. The final set of locations of interest may include locations of interest from each of the plurality of local location engines 130 or at least a portion of the first plurality of locations of interest.

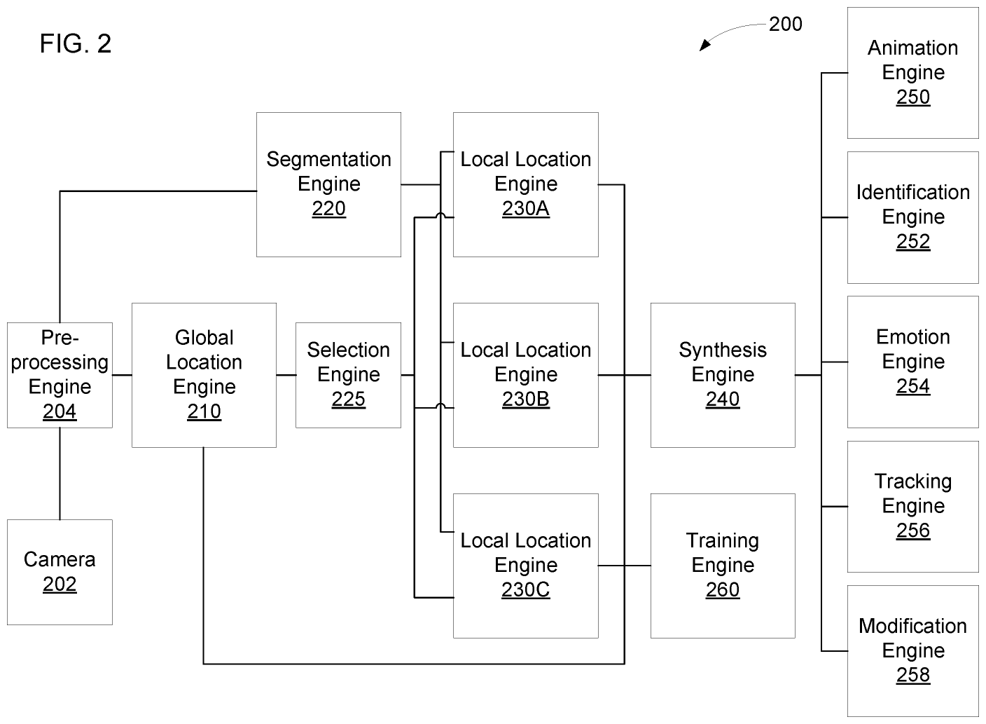

FIG. 2 is a block diagram of another example system 200 to identify locations of interest in an image. The system 200 may include a camera 202. The camera 202 may capture the image. The image may be a still frame or may be an image frame in a video. The image may include a face. In some examples in which the image includes a face, the locations of interest may be facial landmarks for the face in the image. The system 200 may include a pre-processing engine 204. The pre-processing engine 204 may prepare the image for analysis. For example, the pre-processing engine 204 may identify a face in the image, and the pre-processing engine 204 may crop the face from the image to create a cropped image. The pre-processing engine 204 may upscale or downscale the cropped image to be a predetermined size. The output from the pre-processing engine 204 may be a pre-processed image.

The system 200 may include a global location engine 210. The global location engine 210 may identify a first plurality of locations of interest in the image (e.g., in the pre-processed image), such as a first plurality of locations of facial landmarks for the face in the image. The global location engine 210 may identify the first plurality of locations based on a first neural network (e.g., a first convolutional neural network). The first neural network may include a convolutional layer, a pooling layer, and a fully connected layer. In an example, the first neural network may include a plurality of each type of layer. The first neural network may include a Visual Geometry Group (VGG) style network structure. The global location engine 210 may use the image as an input to the first neural network. The input may be a three-dimensional array including a plurality of two-dimensional arrays of grayscale values (e.g., two-dimensional arrays for a red component, a green component, or a blue component of the image). The global location engine 210 may generate a plurality of cartesian coordinates indicating the locations of interest as an output from the first neural network. The locations of interest may be arranged in a predetermined order so that, for example, the locations of interest correspond to a predetermined point on the face without any other indication of the body part to which the location of interest corresponds.

The system 200 may include a segmentation engine 220. The segmentation engine 220 may generate a regional image based on the image (e.g., based on the pre-processed image). For example, the regional image may be a cropped image of a particular facial body part. The facial body part may be a left eye, a right eye, a mouth, an eyebrow, a nose, or the like. In an example, the segmentation engine 220 may identify the facial body parts based on the first plurality of locations of interest determined by the global location engine 210. The segmentation engine 220 may determine the locations of the facial body parts based on the locations of interest. The locations of interest may circumscribe the facial body part, so the segmentation engine 220 may be able to center the regional image on the facial body part based on the locations of interest. The segmentation engine 220 may select a predetermined size regional image, may determine the size of the regional image based on the locations of interest, or the like.

The system 200 may include a location selection engine 225. The location selection engine 225 may select at least a portion of the first plurality of locations of interest to be analyzed in combination with the regional image. For example, the selection engine 225 may select locations of interest other than those associated with the facial body part in the regional image. Thus, for a regional image containing the left eye, the selection engine 225 may include the locations of interest that do not circumscribe the left eye, and the selection engine 225 may omit the locations of interest circumscribing the left eye. The selection engine 225 may select all locations of interest other than the locations of interest to be omitted, may select a subset of the location of interest other than the locations of interest to be omitted, or the like.

The system 200 may include a plurality of local location engines 230A-C. The local location engines 230A-C may identify second, third, and fourth pluralities of locations of interest associated with a particular facial body part, such as a second, third, and fourth pluralities of locations of facial landmarks associated with particular facial body parts. Each local location engine 230A-C may identify its plurality of locations of interest based on a regional image of the particular facial body part for that local location engine 230A-C and a selected portion of the first plurality of locations of interest to be analyzed with that regional image. For example, the regional images may be of a left eye, a right eye, a mouth, a left eyebrow, a right eyebrow, a nose, a face contour, or the like. The portions of the first plurality of locations of interest to be analyzed with the respective regional images may include portions that omit locations associated with the left eye, the right eye, the mouth, the left eyebrow, the right eyebrow, the nose, the face contour, or the like respectively.

The local location engines 230A-C may identify the second, third, and fourth pluralities of locations of interest based on second, third, and fourth neural networks respectively (e.g., based on second, third, and fourth convolutional neural networks). Each local location engines 230A-C may use as an input to the respective neural network the regional image of the facial body part associated with that particular local location engine 230A-C and the portion of the first plurality of locations of interest associated with that regional image. For example, each neural network may include a convolutional layer, a pooling layer, and a fully connected layer. In an example, each neural network may include a plurality of each type of layer. Each neural network may include a VGG style network structure.

Each local location engine 230A-C may use the regional image of the associated facial body part as an input to the convolutional and pooling layers of the corresponding neural network. The regional image may be a three-dimensional array. Each local location engine 230A-C may use the output from the convolutional and pooling layers as an input to the fully connected layer. Each local location engine 230A-C may also use the portion of the first plurality of locations of interest as an input to the fully connected layer. Each local location engine 230A-C may generate a plurality of cartesian coordinates indicating the locations of interest for a particular facial body part as an output from the corresponding neural network.

The system 200 may include a synthesis engine 240. The synthesis engine 240 may select a final set of locations of interest (e.g., a final set of locations of facial landmarks) based on the first, second, third, and fourth pluralities of locations of interest. In an example, the synthesis engine 240 may include the second, third, and fourth pluralities of locations of interest in the final set of locations of interest. The synthesis engine 240 may include the locations of interest from the first plurality of locations of interest that are not duplicative of the second, third, and fourth locations of interest. For example, the second, third, and fourth pluralities of locations of interest may correspond to a left eye, a right eye, and a mouth. The synthesis engine 240 may include the locations of interest from the first plurality of locations of interest that correspond to a left eyebrow, a right eyebrow, a nose, and a face contour but not include the location of interest from the first plurality of locations of interest that correspond to the left eye, the right eye, and the mouth.

The system 200 may include an animation engine 250, an identification engine 252, an emotion engine 254, a tracking engine 256, or a modification engine 258. The animation engine 250 may modify a face of an animated character based on the final set of locations of interest. For example, the animation engine 250 may modify the facial expression of the animated character to match the facial expression of a user. The identification engine 252 may identify a face in the image based on the final set of locations of interest or the image. For example, the identification engine 252 may use the final set of locations of interest or the image as an input to a neural network. The emotion engine 254 may identify an emotion of the face based on the final set of locations of interest or the image. For example, the emotion engine 254 may use the final set of locations of interest or the image as an input to a neural network. The tracking engine 256 may use the final set of locations of interest to determine a location of a face in the image and to update that location as the face moves. The tracking engine 256 may determine a bounding box for the face based on the final set of locations of interest. The modification engine 258 may modify the image based on the final set of locations of interest. For example, the modification engine 258 may add virtual makeup or decorations to the image, may distort the image, or the like. The modification engine 258 may transmit the modified image to a remote device. For example, a user may select a modification to be applied to the image and may select another user to receive the modified image.

The system 200 may include a training engine 260. The training engine 260 may compare the first, second, third, fourth, or final set of locations of interest to true values for the locations of interest. The true values for the locations of interest may have been determined by a user, another system, or the like. The training engine 260 may compute an error using a loss function, which may include computing the difference, the ratio, the mean squared error, the absolute error, or the like between the first, second, third, fourth, or final set of locations of interest and the true values for the locations of interest. The training engine 260 may update the first, second, third, or fourth neural networks based on the comparison. For example, the training engine 260 may backpropagate the error through the first, second, third, or fourth neural networks and update weights of the neurons in the neural networks by performing a gradient descent on the loss function. The training engine 260 may independently train each of the first, second, third, or fourth neural networks, or the training engine 260 may backpropagate the error through multiple networks.

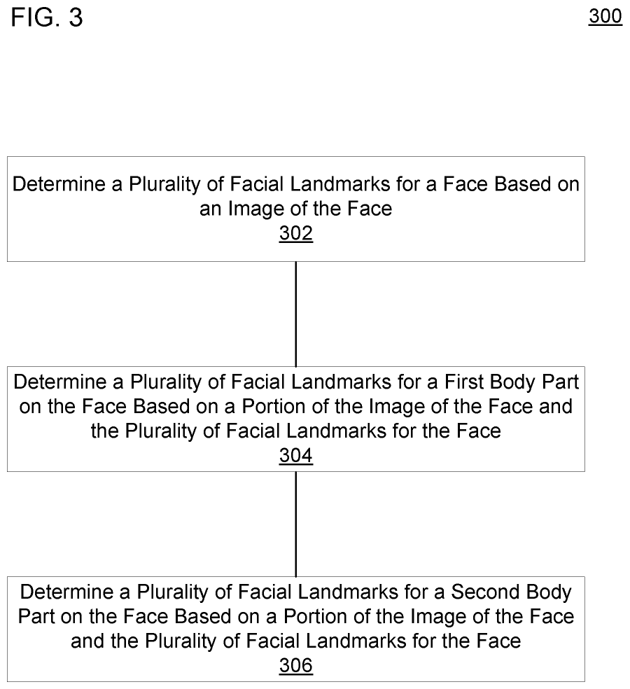

FIG. 3 is a flow diagram of an example method 300 to determine facial landmarks in an image. A processor may perform the method 300. At block 302, the method 300 may include determining a plurality of facial landmarks for a face based on an image of the face and a first neural network. For example, the image of the face may be used an input to the first neural network. The neural network may output a plurality of locations, and each location may correspond to a facial landmark for the face.

Block 304 may include determining a plurality of facial landmarks for a first body part on the face based on a second neural network. The plurality of facial landmarks for the first body part may be determined based on at least a first portion of the image of the face. The at least the first portion of the image may be used as an input to the second neural network and may be smaller or the same size as the image used at block 302 to determine the plurality of facial landmarks for the face. The plurality of facial landmarks for the first body part may be determined based on at least a first portion of the plurality of facial landmarks for the face. The at least the first portion of the plurality of facial landmarks for the face also, or instead, may be used as an input to the second neural network and may be smaller or the same size as the entirety of the plurality of facial landmarks for the face determined at block 302.

At block 306, the method 300 may include determining a plurality of facial landmarks for a second body part on the face based on a third neural network. The plurality of facial landmarks for the second body part may be determined based on at least a second portion of the image of the face or at least a second portion of the plurality of facial landmarks for the face. The at least the second portion of the image or the at least the second portion of the plurality of facial landmarks for the face may be used as an input to the third neural network. The second portion of the image may be smaller or the same size as the entire image, and the second portion of the plurality of facial landmarks for the face may be smaller or the same size as the entirety of the plurality of facial landmarks for the face. Referring to FIG. 2, in an example, the global location engine 210 may perform block 302; one of local location engines 230A-C may perform block 304; and another of the local location engines 230A-C may perform block 306.

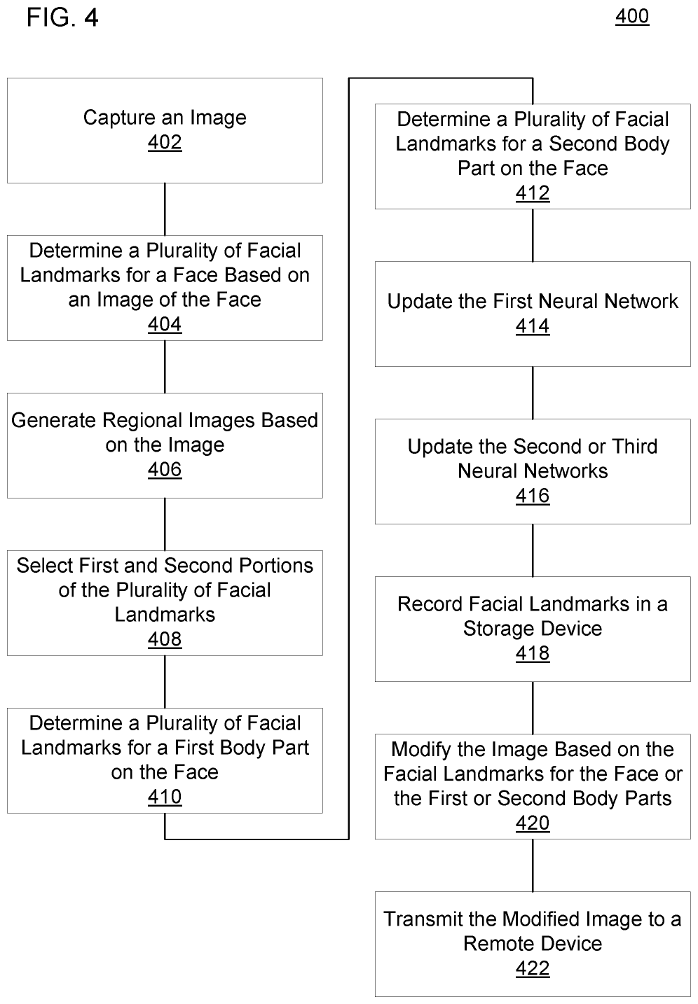

FIG. 4 is a flow diagram of another example method 400 to determine facial landmarks in an image. A processor may perform the method 400. At block 402, the method 400 may include capturing an image. For example, a camera may capture the image and store the image digitally. The image may include a face. Block 404 may include determining a plurality of facial landmarks for the face based on the image of the face and a first neural network. For example, the image of the face may be an input to the first neural network, and a plurality of cartesian coordinates corresponding to the locations of the plurality of facial landmarks may be an output from the first neural network.

At block 406, the method 400 may include generating regional images based on the image. For example, generating the regional images may include generating a first regional image of a first body part of the face and a second regional image of a second body part of the face. The first regional image may include at least a first portion of the image of the face, and the second regional image may include at least a second portion of the image of the face. In examples, there may be more or fewer than two regional images. The location of the first or second body part may be determined based on the plurality of facial landmarks determined at block 404.

Block 408 may include selecting at least a first portion of the plurality of facial landmarks to associate with the first regional image and selecting at least a second portion of the plurality of facial landmarks to associate with the second regional image. Selecting the first portion of the plurality of facial landmarks may include not selecting facial landmarks associated with the first body part in the first regional image. Similarly, selecting the second portion of the plurality of facial landmarks may include not selecting facial landmarks associated with the second body part in the second regional image. The first or second portions of the plurality of facial landmarks may include some or all of the facial landmarks other than those not selected. In some examples, the first portion of the image may be different from the second portion of the image, or the first portion of the plurality of facial landmarks may be different from the second portion of the plurality of facial landmarks.

At block 410, the method 400 may include determining a plurality of facial landmarks for the first body part based on a second neural network. The plurality of facial landmarks for the first body part may be determined based on the first regional image and the at least the first portion of the plurality of facial landmarks. For example, the second neural network may be a convolutional neural network. The first regional image may be used as an input to convolutional and pooling layers of the second neural network. The output from the convolutional and pooling layers and the at least the first portion of the plurality of facial landmarks may be used as inputs to a fully connected layer of the second neural network. For example, the output from the convolutional and pooling layers and the at least the first portion of the plurality of facial landmarks may be concatenated and the concatenated result may be used as an input to the fully connected layer of the second neural network. The output from the fully connected layer may be the plurality of facial landmarks for the first body part. In some examples, the second neural network may include a plurality of fully connected layers.

Block 412 may include determining a plurality of facial landmarks for the second body part based on a third neural network. The plurality of facial landmarks for the second body part may be determined based on the second regional image and the at least the second portion of the plurality of facial landmarks. For example, the second regional image may be an input to a plurality of convolutional and pooling layers of the third neural network, and the output from the plurality of convolutional and pooling layers may be input into a fully connected layer with the at least the second portion of the plurality of facial landmarks. The output from the fully connected layer may be the plurality of facial landmarks for the second body part. In some examples, the second neural network may include a plurality of fully connected layers.

At block 414, the method 400 may include updating the first neural network based on a comparison of the plurality of facial landmarks for the face to a plurality of true landmarks for the face. The image of the face may be part of a training set of images, and the true landmarks for the face may have been previously determined as the landmarks that should be output by the first neural network. Updating the first neural network may include backpropagating an error computed from the comparison to adjust the weights of the first neural network. Block 416 may include updating the second or third neural network based on a comparison of the plurality of facial landmarks for the first or second body part respectively to a plurality of true landmarks for the first or second body part respectively. In an example, the same training set may be used for the first, second, or third neural network by selecting the appropriate true landmarks from the training set. Updating the second or third neural network may include backpropagating an error computed from the comparison to adjust the weights of the second or third neural network.

At block 418, the method 400 may include recording the plurality of facial landmarks for the face or for the first or second body parts in a storage device, such as a volatile or non-volatile computer-readable medium. In an example, the facial landmarks may be stored in a local or remote database. For example, the facial landmarks may be stored where they can be later accessed for further processing. At block 420, the method 400 may include modifying the image based on the plurality of facial landmarks for the face or for the first or second body parts. For example, digital makeup or decorations may be added to the face or the first or second body parts, or the face or the first or second body parts may be distorted. Alternatively, or in addition, modifying the image may include aligning the face in the image. For example, the image may be rotated or scaled so that the face is normalized. The normalized face may be used as an input, e.g., to a face identification or emotion recognition operation. Block 422 may include transmitting the modified image to a remote device. For example, a user may capture the image of themselves, select a modification for the image, and select another user associated with the remote device to whom to transmit the modified image. In an example, the camera 202 of FIG. 2 may perform block 402; the global location engine 210 may perform block 404; the segmentation engine 220 may perform block 406; the selection engine 225 may perform block 408; the local location engines 230A-C may perform block 410 or 412; the training engine 260 may perform block 414 or 416; the synthesis engine 240 may perform block 418; or the modification engine 258 may perform block 420 or 422. In some examples, some of the blocks of the methods 300 or 400 may be rearranged or omitted, or additional blocks may be added. For example, the operations of the animation engine 250, the identification engine 252, the emotion engine 254, or the tracking engine 256 may be included in addition to, or instead of, the operations of the modification engine 258.

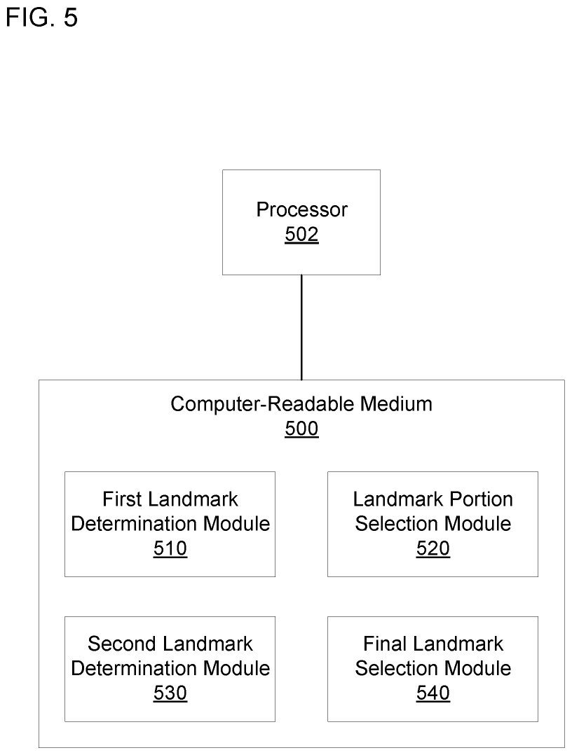

FIG. 5 is a block diagram of an example computer-readable medium 500 including instructions that, when executed by a processor 502, cause the processor 502 to determine facial landmarks in an image. The computer-readable medium 500 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 502 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc. The computer-readable medium 500 or the processor 502 may be distributed among a plurality of computer-readable media or a plurality of processors.

The computer-readable medium 500 may include a first landmark determination module 510. As used herein, a “module” (in some examples referred to as a “software module”) is a set of instructions that when executed or interpreted by a processor or stored at a processor-readable medium realizes a component or performs a method. The first landmark determination module 510 may include instructions that, when executed, cause the processor 502 to determine a first plurality of facial landmarks based on an image. For example, the first landmark determination module 510 may cause the processor 502 to analyze the image to identify facial landmarks corresponding to body parts on a face in the image.

The computer-readable medium 500 may include a landmark portion selection module 520. The landmark portion selection module 520 may cause the processor 502 to select a portion of the first plurality of facial landmarks. The landmark portion selection module 520 may cause the processor 502 to not include landmarks for a facial body part of interest when selecting the portion from the first plurality of facial landmarks.

The computer-readable medium 500 may include a second landmark determination module 530. The second landmark determination module 530 may cause the processor 502 to determine a second plurality of facial landmarks based on at least a portion of the image and the portion of the first plurality of facial landmarks (e.g., the portion of the first plurality of facial landmarks selected by the landmark portion selection module 520). The at least the portion of the image may include the facial body part of interest, and the second plurality of facial landmarks may include facial landmarks corresponding to the facial body part of interest.

The computer-readable medium 500 may include a final landmark selection module 540. The final landmark selection module 540 may cause the processor 502 to select a final plurality of facial landmarks based on the first and second pluralities of facial landmarks. The first and second pluralities of facial landmarks may include redundant facial landmarks between each other. For example, the first and second pluralities may include facial landmarks corresponding to the same facial body part. The final landmark selection module 540 may cause the processor 502 to select the final plurality of facial landmarks so there are no redundant facial landmarks in the final plurality. In an example, when executed by the processor 502, the first landmark determination module 510 may realize the global location engine 210 of FIG. 2; the landmark portion selection module 520 may realize the selection engine 225; the second landmark determination module 530 may realize one of the local location engine 230A-C; and the final landmark selection module 540 may realize the synthesis engine 240.

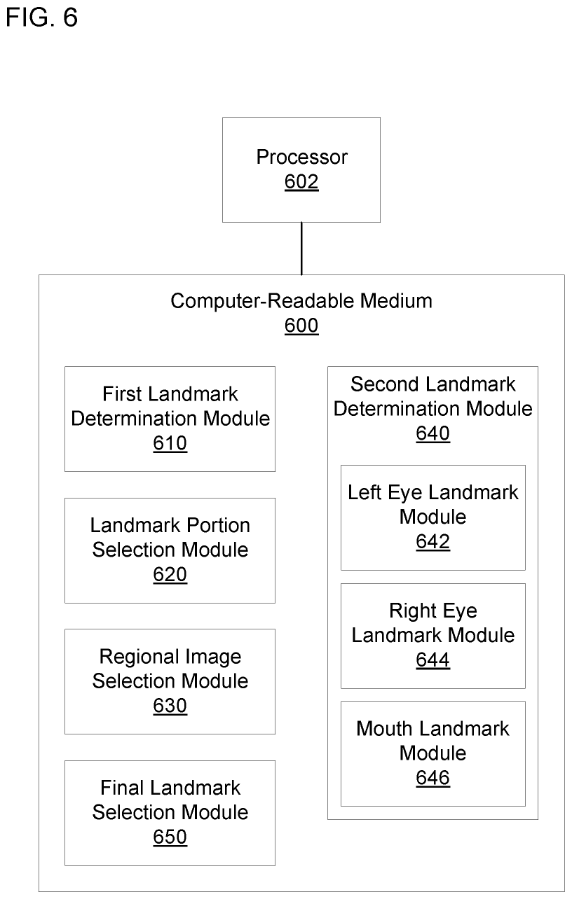

FIG. 6 is a block diagram of another example computer-readable medium 600 including instructions that, when executed by a processor 602, cause the processor 602 to determine facial landmarks in an image. The computer-readable medium 600 may include a first landmark determination module 610. The first landmark determination module 610 may cause the processor 602 to determine a first plurality of facial landmarks based on an image. The first landmark determination module 610 may cause the processor 602 to determine the first plurality of facial landmarks based on a first convolutional neural network. For example, the first landmark determination module 610 may cause the processor 602 to simulate the first convolutional neural network and use the image as an input to the first convolutional neural network. The first convolution neural network may be trained to output the first plurality of facial landmarks based on the image.

The computer-readable medium 600 may include a landmark portion selection module 620. The landmark portion selection module 620 may cause the processor 602 to select a portion of the first plurality of facial landmarks without including facial landmarks for a facial body part of interest in the selected portion. For example, the portion of the first plurality of facial landmarks may be used for more precisely determining facial landmarks for the facial body part of interest, so the initially determined facial landmarks for the facial body part of interest may be disregarded. The landmark portion selection module 620 may cause the processor 602 to include some or all of the facial landmarks not disregarded. In an example, facial landmarks for the left eye, the right eye, and the mouth may be determined more precisely. The landmark portion selection module 620 may cause the processor 602 select three portions of the first plurality of facial landmarks: a first portion not including facial landmarks for the left eye, a second portion not including facial landmarks for the right eye, and a third portion not including facial landmarks for the mouth. In other examples, the facial body part of interest may be a right eyebrow, left eyebrow, nose, face contour, or the like.

The computer-readable medium 600 may include a regional image selection module 630. The regional image selection module 630 may cause the processor 602 to crop the image to produce a regional image that includes the facial body part of interest. For example, the regional image selection module 630 may cause the processor 602 to produce a first regional image of the left eye, a second regional image of the right eye, and a third regional image of the mouth. In some examples, the regional image selection module 630 may cause the processor 602 to little of the face other than the facial body part of interest in the regional image. The regional image selection module 630 may cause the processor 602 to determine the location of the facial body part of interest based on the first plurality of facial landmarks.

The computer-readable medium 600 may include a second landmark determination module 640. The second landmark determination module 640 may cause the processor 602 to determine a second plurality of facial landmarks based on the regional image corresponding to the facial body part of interest and the portion of the first plurality of facial landmarks corresponding to the facial body part of interest. The second landmark determination module 640 may cause the processor 602 to determine the second plurality of facial landmarks based on a second convolutional neural network. For example, the second landmark determination module 640 may cause the processor 602 to simulate the second convolutional neural network and use the regional image and the portion of the facial landmarks as inputs to the second convolutional neural network. The second landmark determination module 640 may cause the processor 602 to use the regional image as an input to convolutional and pooling layers and the portion of the facial landmarks as an input to a fully connected layer as previously discussed. The second convolutional neural network may be trained to output the second plurality of facial landmarks for the facial body part of interest based on the regional image and the portion of the facial landmarks.

The second landmark determination module 640 may include a left eye landmark module 642, a right eye landmark module 644, and a mouth landmark module 646. The left eye landmark module 642 may cause the processor 602 to determine facial landmarks for the left eye based on the first regional image of the left eye and the first portion of the plurality of facial landmarks. The right eye landmark module 644 may cause the processor 602 to determine facial landmarks for the right eye based on the second regional image of the right eye and the second portion of the plurality of facial landmarks. The mouth landmark module 646 may cause the processor 602 to determine facial landmarks for the mouth based on the third regional image of the mouth and the third portion of the plurality of facial landmarks. For example, each of the left eye landmark module 642, the right eye landmark module 644, and the mouth landmark module 646 may include a unique convolutional neural network trained to determine landmarks for that particular facial body part. Any of the left eye landmark module 642, the right eye landmark module 644, and the mouth landmark module 646 may include the second convolutional neural network, and the others of the left eye landmark module 642, the right eye landmark module 644, and the mouth landmark module 646 may include third or fourth convolutional neural networks structured similar to the second convolutional neural network. In some examples, the second landmark determination module 640 may also, or instead, include modules for a right eyebrow, a left eyebrow, a nose, a face contour, or the like.

The computer-readable medium 600 may include a final landmark selection module 650. The final landmark selection module 650 may cause the processor 602 to select a final plurality of facial landmarks based on the first and second pluralities of facial landmarks. In some examples, the final landmark selection module 650 may cause the processor 602 to not select redundant landmarks from the first and second landmark determination modules 610, 640. In an example, the final landmark selection module 650 may cause the processor 602 to select facial landmarks determined by the second landmark determination module 640 when those facial landmarks are available and to select facial landmarks determined by the first landmark determination module 610 when a corresponding facial landmark is not available from the second landmark determination module 640. For example, the final landmark selection module 650 may cause the processor 602 to select the facial landmarks for the left eye determined by the left eye landmark module 642, the facial landmarks for the right eye determined by the right eye landmark module 644, and the facial landmarks for the mouth determined by the mouth landmark module 646. The final landmark selection module 650 may also cause the processor 602 to select facial landmarks from the first plurality of facial landmarks other than facial landmarks corresponding to the left eye, the right eye, or the mouth. For example, the final landmark selection module 650 may cause the processor 602 to select some or all of facial landmarks from the first plurality of facial landmarks that do not correspond to the left eye, the right eye, or the mouth. In examples where the second landmark determination module 640 determines facial landmarks for a facial body part other than the left eye, the right eye, and the mouth, the final landmark selection module 650 may cause the processor 602 to exclude facial landmarks corresponding to that facial body part from the facial landmarks selected from the first plurality of facial landmarks. Referring to FIG. 2, in an example, when executed by the processor 602, the first landmark determination module 610 may realize the global location engine 210; the landmark portion selection module 620 may realize the selection engine 225; the regional image selection module 630 may realize the segmentation engine 220; the second landmark determination module 640, the left eye landmark module 642, the right eye landmark module 644, or the mouth landmark module 646 may realize any of the local location engines 230A-C; and the final landmark selection module 650 may realize the synthesis engine 240.

The above description is illustrative of various principles and implementations of the present disclosure. Numerous variations and modifications to the examples described herein are envisioned. Accordingly, the scope of the present application should be determined only by the following claims.

What is claimed is:

1. A system comprising:
a global location engine to identify a first plurality of locations of interest in an image, wherein the global location engine is to identify the first plurality of locations based on a first neural network;
a segmentation engine to generate a regional image based on the image; and
a local location engine to identify a second plurality of locations of interest based on the regional image and at least a portion of the first plurality of locations of interest, wherein the local location engine is to identify the second plurality of locations of interest based on a second neural network.

2. The system of claim 1, wherein the global location engine is to identify the first plurality of locations by identifying facial landmarks, and wherein the local location engine is to identify the second plurality of locations by identifying facial landmarks associated with a particular facial body part.

3. The system of claim 2, wherein the portion of the first plurality of locations includes facial landmarks identified by the global location engine without including the facial landmarks associated with the particular facial body part.

4. The system of claim 2, further comprising a synthesis engine to select a final set of facial landmarks based on the first plurality of locations and the second plurality of locations.

5. The system of claim 4, further comprising an identification engine to identify a face in the image based on the final set of facial landmarks and the image.

6. A method, comprising:
determining a plurality of facial landmarks for a face based on an image of the face and a first neural network; and
determining a plurality of facial landmarks for a first body part on the face based on at least a first portion of the image of the face, at least a first portion of the plurality of facial landmarks for the face, and a second neural network; and
determining a plurality of facial landmarks for a second body part on the face based on at least a second portion of the image of the face, at least a second portion of the plurality of facial landmarks for the face, and a third neural network.

7. The method of claim 6, wherein the first portion of the image is different from the second portion of the image and the first portion of the plurality of facial landmarks for the face is different from the second portion of the plurality of facial landmarks for the face.

8. The method of claim 6, wherein determining the plurality of facial landmarks for the first body part comprises computing an output from a convolutional layer of the second neural network and providing the output from the convolutional layer and the at least the first portion of the plurality of facial landmarks to a fully connected layer of the second neural network.

9. The method of claim 6, further comprising updating the first neural network based on a comparison of the plurality of facial landmarks for the face to a plurality of true landmarks for the face, and updating the second neural network based on a comparison of the plurality of facial landmarks for the first body part to a plurality of true landmarks for the first body part.

10. The method of claim 6, further comprising capturing an image, modifying the image based on the plurality of facial landmarks for the first body part and the plurality of facial landmarks for the second body part, and transmitting the modified image to a remote device.

11. A non-transitory computer-readable medium comprising instructions that, when executed by a processor, cause the processor to:
determine a first plurality of facial landmarks based on an image;
select a portion of the first plurality of facial landmarks without including in the portion facial landmarks for a facial body part of interest from the first plurality of facial landmarks;
determine a second plurality of facial landmarks based on at least a portion of the image and the portion of the first plurality of facial landmarks; and
select a final plurality of facial landmarks based on the first and second pluralities of facial landmarks.

12. The computer-readable medium of claim 11, wherein the instructions, when executed, cause the processor to determine the first plurality of facial landmarks based on a first convolutional neural network and the second plurality of facial landmarks based on a second convolutional neural network.

13. The computer-readable medium of claim 11, further comprising instructions that, when executed, cause the processor to crop the image to produce a regional image that includes the facial body part of interest.

14. The computer-readable medium of claim 11, wherein the instructions to cause the processor to determine the second plurality of facial landmarks include instructions to cause the processor to determine facial landmarks for a left eye based on a region of the image including the left eye, determine facial landmarks for a right eye based on a region of the image including the right eye, and determine facial landmarks for a mouth based on a region of the image including the mouth.

15. The computer-readable medium of claim 14, wherein the instructions to cause the processor to select the final plurality of facial landmarks include instructions to cause the processor to select the facial landmarks for the left eye, the facial landmarks for the right eye, the facial landmarks for the mouth, and facial landmarks from the first plurality of facial landmarks other than facial landmarks corresponding to the left eye, the right eye, or the mouth.
